(19) United States
(12) Patent Application Publication
(10) Pub. No.: US 2005/0151633 A1
(43) Pub. Date: Jul. 14, 2005

(54) Electronic gauge translator for ECU equipped engines

(75) Inventors: Robert Joseph Murphy, Palmdale, CA (US); John Harvey Murphy, Palmdale, CA (US)

Correspondence Address: ROBERT JOSEPH MURPHY, 41343 12TH STREET WEST, PALMDALE, CA, 93551, US

(73) Assignee: DE SISTI LIGHTING S.p.A.

(21) Appl. No.: 10/964,110

(22) Filed: Oct. 13, 2004

Related U.S. Application Data
(60) Provisional application No. 60/515,801, filed on Oct. 29, 2003.

(51) Int. Cl. B60Q 1/00

(52) U.S. Cl. 340/438; 340/441; 710/315

(57) ABSTRACT

A microprocessor based electronic gauge translator which communicates with an engine control unit (ECU) via a common control area network and drives standard gauges from a variety of manufacturers. Such engine control units provide critical engine information using standard and proprietary codes that are readable by the electronic gauge translator. This information is then converted to signals, which are used to drive standard gauges with air core, D'Arsonval and other similar type movements.

### FIELD OF INVENTION

This invention relates to electronically controlled engines, specifically reading the data from a serial communications port and then generating the proper electrical signal needed to drive standard commercially available gauges.

### BACKGROUND OF THE INVENTION

Historically, information relating to the operation of an internal combustion engine was displayed through discreet senders and associated gauges. The gauge movements in these gauges were arranged and connected to respond to a particular sensed condition. The sensed condition typically may be pressure, temperature, fluid level or an electrical characteristic. Examples of various movements that may be utilized within the gauge are air core, D'Arsonval and other similar type movements. The movement is connected to a reading pointer which typically passes over a gauge face plate to provide a visual reading of the sensed condition relative to graduations or other markings provided on the face plate or dial plate that corresponds to the condition being sensed.

Since the mid 1980's the automobile industry has sought to develop and is continuing to develop in-vehicle computer networks. These networks include microprocessor based engine control units (ECU), (also known as engine control modules (ECM) and other similar wording) that provide critical engine information and control using manufacturers proprietary codes that are readable on the in-vehicle computer network. The ECU is connected to several sensors and sending units on the engine, including the type of discrete sensors once used to drive individual gauges and instrument panels.

Several institutions have set standards regarding these microprocessor based ECU networks. In the early 90's, the Society of Automotive Engineers (SAE) Truck and Bus Control and Communications Sub-committee started the development of a CAN-based application profile for in-vehicle communication in trucks. In 1998 the SAE published the J1939 set of specifications supporting SAE class A, B, and C communication functions. A J1939 network connects ECU's within a truck and trailer system. The J1939 specification—with its engine, transmission, and brake message definitions—is dedicated to diesel engine applications. It is supposed to replace earlier in-vehicle networks based on the J1587/J1708 protocols and similar protocols.

Other industries adopted these general in-vehicle communication functions, in particular the J1939/21 and J1939/31 protocol definitions—which are required for any J1939—compatible system. They added other physical layers and they defined other application parameters. The International Organization for Standardization (ISO) standardized the J1939—based truck and trailer communication (ISO 11992) and the J1939-based communication for agriculture and forestry vehicles (ISO 11783). The National Marine Electronics Association (NMEA) specified the J1939-based communication for navigation systems in marine applications (NMEA 2000). Industry-specific documents define the particular combination of layers for that industry.

These ECU's are found on industrial engines in part to manage engine performance to meet government emission (EPA) standards. Such ECU's utilize this data network and communications protocol to communicate with other devices via a serial bus transceiver as will be understood by those skilled in the art. The serial bus transceiver provides critical engine performance and operation information including, but not limited to engine oil pressure, oil temperature, fuel level, engine RPM, engine hours, as well as battery voltage. While this information is available on the ECU's data network it is not usable in its native format to drive standard gauges. While it is possible to add a second set of senders to drive gauges to display engine information, this is a costly and time-consuming process requiring duplication of effort and resources to retrieve data that is already available on the in-vehicle network. Several manufacturers, including VDO, Faria, Teleflex, and Frank W Murphy Manufacturing have attempted to overcome this limitation by reading the data from the in-vehicle network and then converting the data into an electronic signal that can be read and displayed by proprietary gauges using proprietary communications protocols. This method is not usable by standard gauges. While this has eliminated the duplication of effort required to install a second set of senders, this approach has proven to be prohibitively expensive and requires tooling and wiring changes to install these systems. They also require proprietary gauges that change the “look and feel” of the instrument panels.

Our patent describes a method to read the in-vehicle network and generate the electronic signal required to drive standard gauges that have historically been commercially available from several manufactures. Nevertheless current in-vehicle network gauges heretofore known suffer from a number of disadvantages:

(a) Current standard gauges require a second set of senders to drive the gauges. This increases the cost and effort to install the gauges and results in a duplication of effort of work already preformed by the engine manufacturers.

(b) Gauge drivers based on the in-vehicle network require proprietary gauges that are prohibitively expensive. Gauges designed for in-vehicle networks have complex and costly electronic circuits used to drive the gauges increasing the cost and complexity needed to install, maintain, and repair the in-vehicle network based gauges.

(C) Proprietary gauges change the look and feel of current instrument panels. Many manufactures differentiate themselves through the distinctive look and feel of their instrument panels. Using gauges that are new to the manufacturer forces them to change the design of the instrument panel to accommodate the installation of in-vehicle network based gauges.

(d) Proprietary gauge systems based on the in-vehicle network increase the complexity of the overall system.

Accordingly, besides the objects and advantages of the in-vehicle network to standard gauge driver described in our above patent, several objects and advantages of the present Patent Application of Robert J. Murphy and John H. Murphy for “Electronic Gauge Translator for ECU Equipped Engines”. invention are:

(a) Standard gauges can be used to display engine information with an engine having an in-vehicle network without the addition of gauge sending units.

(b) Standard gauges are available from several manufactures and are less expensive than other gauge drivers based on the in-vehicle network that require proprietary gauges.

(c) Standard gauges provide for the same “look and feel” of current instrument panels used by industry.

(d) Standard gauges are known and accepted by industry and provide no increase in the complexity of the overall system.

Further objects and advantages are to provide for ease in adapting existing standard gauges from a variety of manufacturers to ECU equipped engines. This invention is easier to wire and install than other products currently available. This invention adjusts to a wide range of ECU modules and gauge types. This invention can drive multiple gauge types and design from multiple manufactures. Further Objects and Advantages of our invention will become apparent from a consideration of the drawings and ensuing description.

### SUMMARY

In accordance with the present invention a device that converts data from an ECU equipped engine to signals able to drive a wide variety of standard automotive, industrial, and marine style gauges from many manufactures.

### BRIEF DESCRIPTION OF THE DRAWINGS

A complete understanding of the present invention may be obtained by reference to the accompanying drawings, when considered with the subsequent, detailed description, in which:

FIG. 1 shows a simplified block diagram of the Electronic Gauge Translator according to the preferred embodiment of the inventions.

FIG. 2 shows a schematic representation of the microprocessor based logic unit.

FIG. 3 shows a schematic representation of circuitry used to configure each output to match the gauge type.

FIG. 4 shows a schematic representation of digital output circuitry.

FIG. 5 shows a schematic representation of the gauge drive output circuitry.

FIG. 6 shows the serial bus transceiver, serial communications port, and status indicator circuitry.

FIG. 7 shows the power supply circuitry according to the preferred embodiment.

FIG. 8 shows a simplified block diagram of the Electronic Gauge Translator with optional and alternate embodiments.

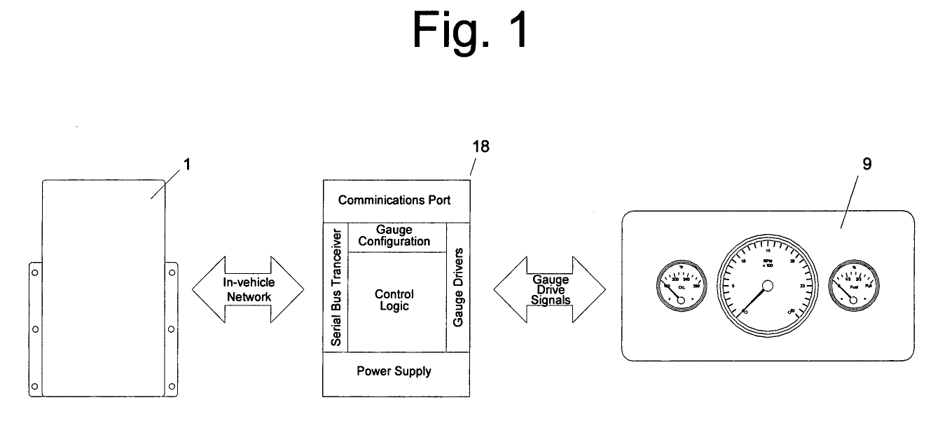

### DETAILED DESCRIPTIONS—FIGS. 1-7 PREFERED EMBODIMENT

A preferred embodiment of the Electronic Gauge Translator is illustrated in FIG. 1. An Electronic Gauge Translator 18 receives data from Engine Control Unit (ECU) 1 and drives the gauges in Generic Gauge Panel 9.

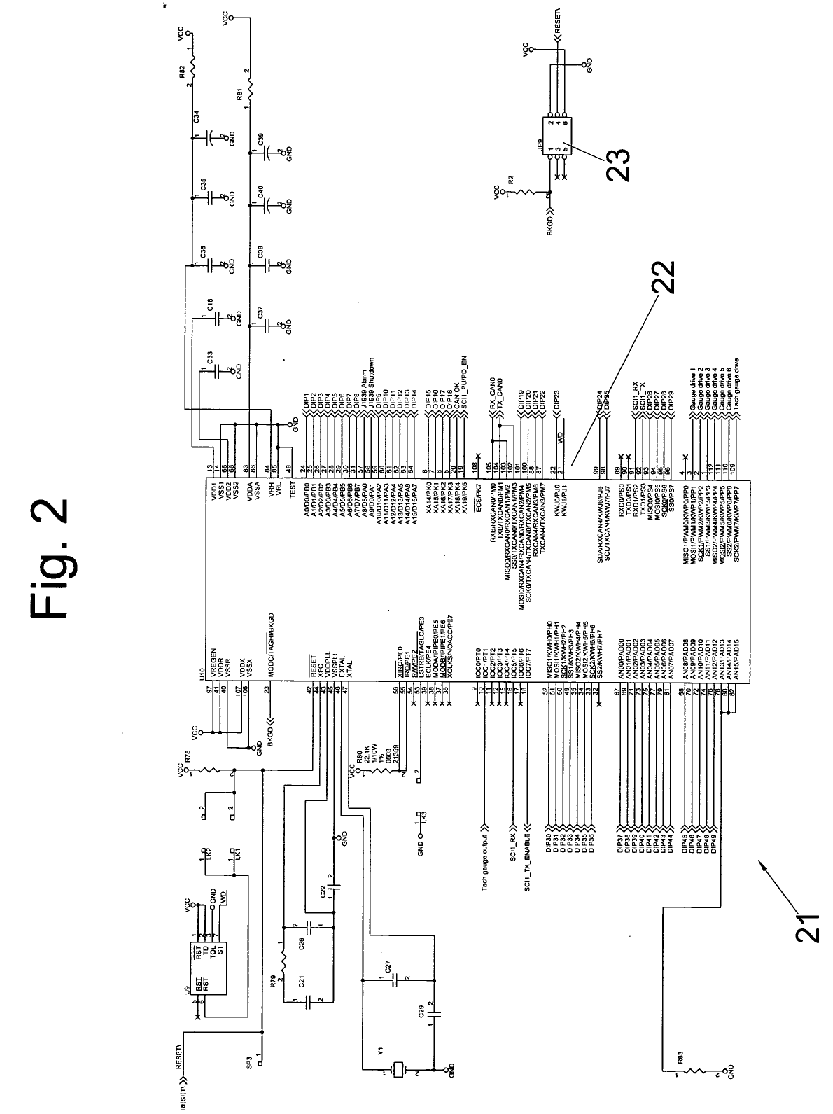

FIG. 2 is a schematic diagram of microprocessor based logic unit 21 in its preferred embodiment. Microprocessor 22, is programmed via programming port 23 to perform the core logic functions of the translator: reading ECU's data network via serial bus transceiver 2 and generate gauge drive signals with gauge drivers variable voltage gauge driver 6 and variable frequency gauge driver 8. Microprocessor 22 also provides data exchange via serial communications port 4.

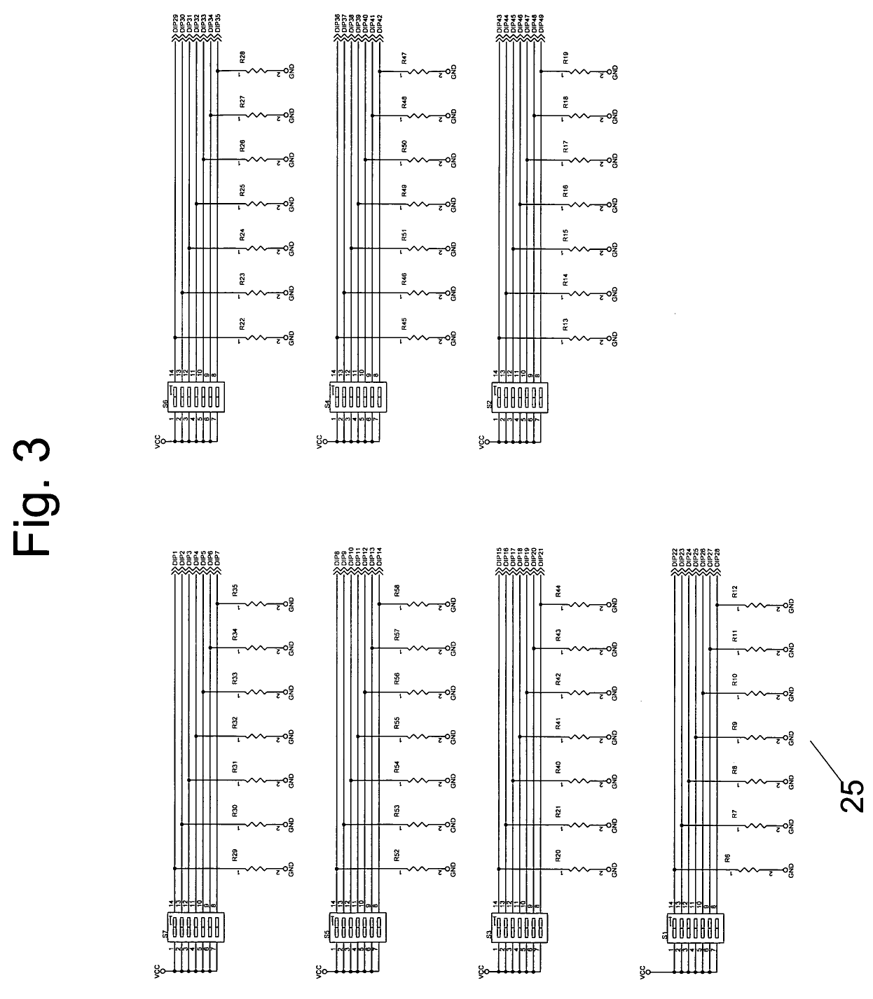

FIG. 3 is a schematic diagram of gauge configuration select circuitry 25. Switches are used to configure each gauge driver output to match the external standard gauge movement's drive characteristics.

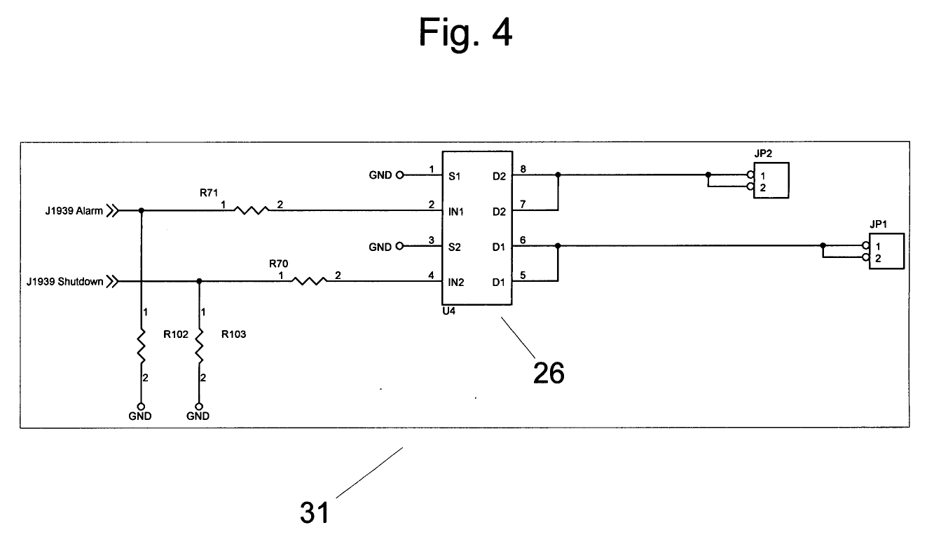

FIG. 4 is a schematic diagram of digital output circuitry 31. Electronic Switch 26 is enabled by microprocessor 22 and is used to drive external loads.

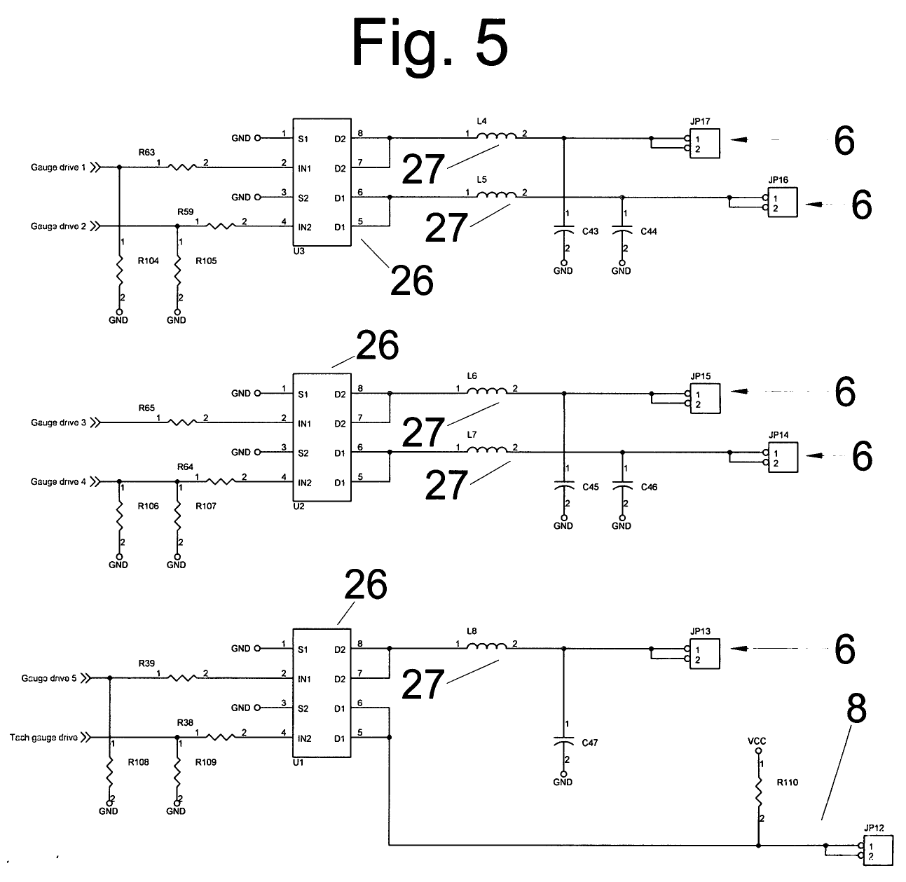

FIG. 5 is a schematic diagram of variable voltage gauge driver 6 and variable frequency gauge driver 8. Microprocessor 22 generates a pulse train of a desired value that turns on and off electronic Switch 26 that allows current to flow through RC network 27 to create variable voltage gauge driver 6 or is used discretely to create variable frequency gauge driver 8.

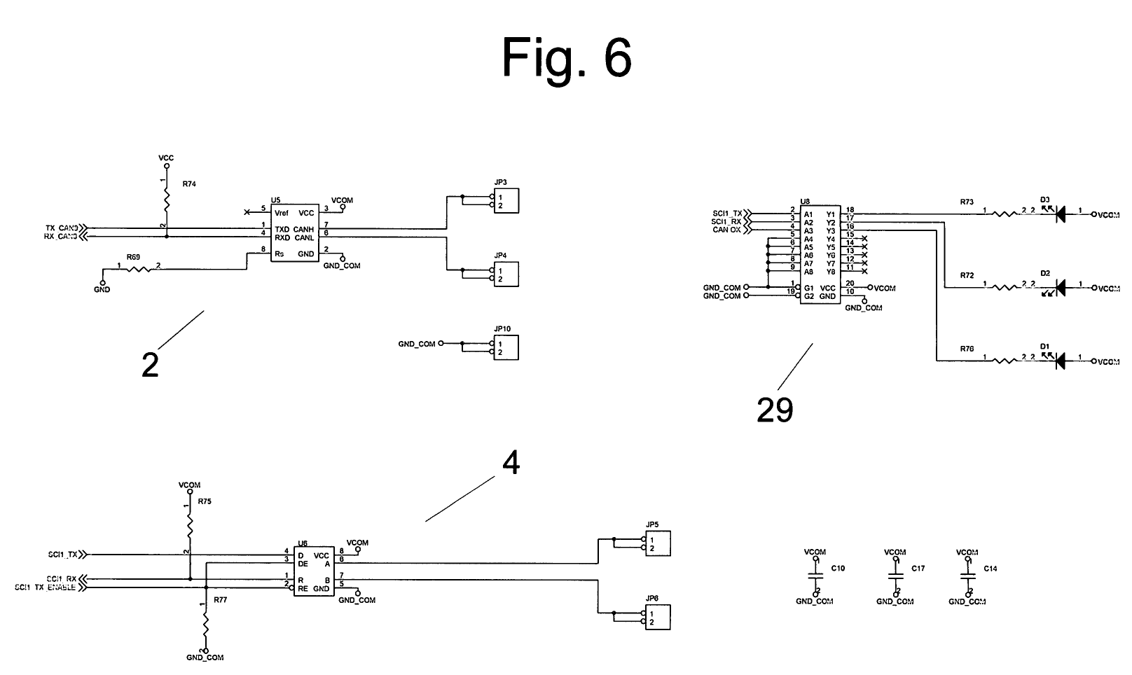

FIG. 6 is a schematic diagram of serial bus transceiver 2, serial communications port 4 and serial bus transceiver status indicators 29.

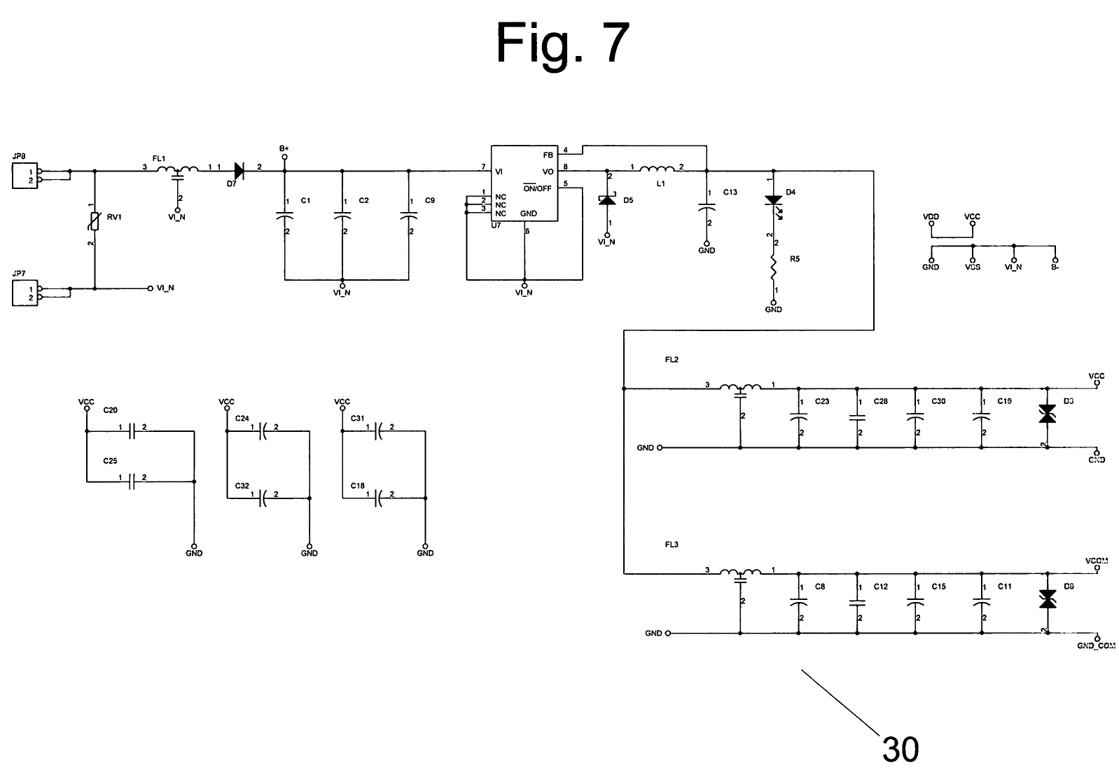

FIG. 7 is a schematic diagram of power supply 30.

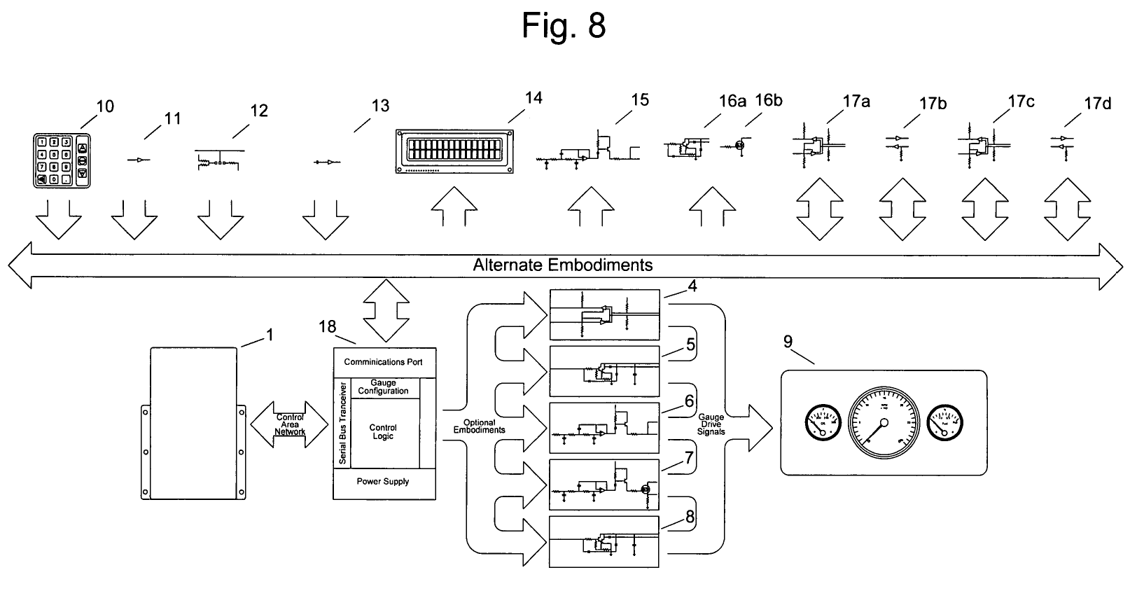

FIGS. 8—Optional and Additional Embodiments.

Optional and additional embodiments of Electronic Gauge Translator 18 are illustrated in FIG. 8. Optionally, electronic gauge translator 18 may utilize any one or all of the gauge driver types; serial communication port 4, pulse width modulation (PWM) gauge driver 5, variable voltage gauge driver 6, variable resistance gauge driver 7 and/or variable frequency gauge driver 8. The driver type is selected to match the gauges in generic gauge panel 9. Although three gauges are shown, any number or types of gauges may be driven.

Alternate embodiments may include keypads 10, digital inputs 11, analog inputs 12, frequency inputs 13, displays 14, analog outputs 15, digital outputs 16a, PWM digital outputs 16b, RS485 serial ports 17a, RS232 serial ports 17b, CAN serial port 17c, and USB serial port 17d.

Operation—FIGS. 1-7

Electronic gauge translator 18 of the invention can be seen in communication with an ECU 1 associated with an engine. The ECU 1 is found on many modern engines. Such ECU's utilize a control area network using a communications protocol standardized by the Society of Automotive Engineers (SAE) and others, which is characterized by digital addressable message protocol allowing communication between multiple ECU's as will be understood by those skilled in the art. Electronic Gauge Translator 18 uses microprocessor 22 and custom software application to read the data seen on the control area network connected to serial bus transceiver 2. The control area network provides critical engine performance and operation information including, but not limited to engine oil pressure, oil temperature, manifold temperature, fuel use rate, engine RPM, engine hours, battery voltage as well as calculated percent of torque, percent of effective load to relative engine RPM and throttle position.

A power supply 30 is used to supply the voltages required by the electrical needs. Microprocessor based logic unit 21 contains required auxiliary circuits required for the microprocessor 22 to operate properly, including but not limited to oscillator, reset and watch dog circuits, programming port 23, and links that may be used to operate, configure and program the microprocessor 22. Serial bus transceiver status indicators 29 and digital output circuitry 31 utilizing electronic switch 26, provide annunciation of the status of the control area network associated with ECU 1. Serial communication port 4 utilizes an RS-485 transceiver to allow access to the electronic gauge translator 18 with external serial enabled devices for configuration and monitoring of microprocessor 22 and the custom software application.

It will be evident from the above description that one of the primary tasks of the electronic gauge translator 18 is to gather specific engine operational parameters supplied by the ECU 1 without the requirement of remote connection to individual sensors as has been required in the past.

By utilization of custom software the microprocessor 22 generates a pulse train proportional to the parameter read from ECU 1 and wired to variable voltage gauge driver 6 and variable frequency driver 8 to drive the external gauges located in generic gauge panel 9. The pulse train turns on and off electronic switch 26 that generates a voltage on RC network 27 that moves the indicator on an external gauge to the desired value on the gauge's display. For gauges requiring a frequency input, variable frequency driver 8 does not utilize RC network 27 and directly drives the external gauge with electronic switch 26.

To accommodate different gauges from a wide variety of manufacturers, gauge configuration select circuitry 25 is used to configure electronic gauge translator 18. Configuration select circuitry 25 is read by microprocessor 22 so that microprocessor 22 may generate properly proportioned pulse train required by the gauge to display the proper value on generic gauge panel 9.

FIG. 8—Optional and Alternate Embodiments

While the above description contains much specificity, these should not be construed as limitations on the scope of the invention, but rather as an exemplification of one preferred embodiment thereof. Many other variations are possible.

For example, Optional embodiments allow for different drive circuits needed to match the characteristic drive required for other industry standard gauges. This would include but is not limited to, serial communication port 4, pulse width modulation (PWM) gauge driver 5, and variable resistance gauge driver 7.

There are various alternate embodiments as illustrated in FIG. 8. Keypad 10 and display 14 can be used in place of gauge configuration select circuitry 25 to modify the operation of the custom software application in microprocessor 22.

To accommodate connection to individual sensors and inputs that are not associated with the control area network, digital input 11, analog input 12, and frequency input 13 circuitry could be added.

To accommodate connection to individual control device and measurement devices analog output 15, digital output 16a and PWM digital output 16b circuitry could be added.

To accommodate communications to multiple ECU's 1, other electronic devices, or a separate communications network, communications port(s) could be added including but not limited to, RS485 serial port 17a, RS232 serial port 17b, CAN serial port 17c, or USB serial port 17d.

Advantages

From the description above a number of advantages of our electronic gauge translator become evident:

(a) Standard gauges can be used to display engine information with an engine having a control area network without the addition of gauge sending units.

(b) Standard gauges are available from several manufactures and are less expensive than other gauge drivers utilizing the control area network that require proprietary gauges.

(c) Standard gauges provide for the same “look and feel” of current instrument panels used by industry.

(d) Standard gauges are known and accepted by industry and provide no increase in the complexity of the overall system.

Further objects and advantages are to provide for ease in adapting existing standard gauges from a variety of manufacturers to ECU equipped engines. This invention is easier to wire and install than other products currently available. This invention adjusts to a wide range of ECU modules and gauge types. This invention can drive multiple gauge types and design from multiple manufactures.

Accordingly, the scope of the invention should not be determined by the embodiment(s) illustrated, but by the appended claims and their legal equivalents.

1. A device to retrieve the information from an electronically controlled engine and translate said information into the electronic signals that are suitable for driving gauge movements originally intended for use with discreet senders, comprising:
(a) computing device for logic, communication and control functions
(b) communicating means for retrieving said information from said electronically controlled engine
(c) driving means suited to said gauge movements
whereby gauge movements intended for use with discreet senders may be used with electronically controlled engines without adding discreet senders.

2. The device of claim 1 further including a means to configure the means of driving the gauge movement utilizing the existing program in the computing device.

3. The device of claim 1 further including a means to annunciate said communications and said electronically controlled engine status.

4. The device of claim 1 further including a means for driving said gauge movement by means of a variable voltage.

5. The device of claim 1 further including a means for driving said gauge movement by means of a variable resistance.

6. The device of claim 1 further including a means for driving said gauge movement by means of a variable frequency.

7. The device of claim 1 further including a means for driving said gauge movement by means of pulse width modulation.

8. The device of claim 1 further including a means for driving said gauge movement by means of serial communications.

9. The device of claim 1 further including a means for reading discrete sensors.

10. The device of claim 1 further including a means for driving discrete control devices.

11. The device of claim 1 further including a means to communicate with other devices with a means for serial communications.
